(19) United States
(12) Patent Application Publication
(10) Pub. No.: US 2024/0413585 A1
(43) Pub. Date: Dec. 12, 2024

(54) Horizontal Connector

(71) Applicant: Shenzhen Glgnet Electronics Co.,Ltd., Shenzhen (CN)

(72) Inventors: Congzhong Wang, Shenzhen (CN); Conghui Wang, Shenzhen (CN); Jianhua Li, Shenzhen (CN)

(21) Appl. No.: 18/812,950

(22) Filed: Aug. 22, 2024

Related U.S. Application Data
(63) Continuation of application No. PCT/CN2024/093695, filed on May 16, 2024.

(30) Foreign Application Priority Data
May 6, 2024 (CN) 202410547694.4

(51) Int. Cl. H01R 13/6471; H01R 12/58; H01R 13/405; H01R 13/502; H01R 13/6473

(52) U.S. Cl. CPC H01R 13/6471; H01R 12/58; H01R 13/405; H01R 13/502; H01R 13/6473

(57) ABSTRACT

The present invention relates to a horizontal connector comprising a casing and several terminal components; the casing is provided with card slots for inserting terminal components and AICs; the terminal components comprise terminal groups and molded parts; the terminal groups comprise ground terminals, first signal terminals and second signal terminals; the casing is uniformly provided with first openings corresponding to terminal heads; the casing is uniformly provided with second openings corresponding to the force arm area of ground terminals; the first openings are provided with serrated inserting holes for limiting the height of terminal heads. By changing the casing structure and optimizing the terminal structure, the characteristic impedance of the terminal groups can be directly optimized and the SI performance of horizontal connectors can be effectively improved, reducing the manufacturing cost for conventional SI performance optimization solutions, simplifying the process, shortening the production time and improving the product qualification rate.

### FIELD OF THE INVENTION

The present invention relates to the plug-in device technology, particularly to a horizontal connector.

### BACKGROUND OF THE INVENTION

A connector is a plug-in device that connects two active devices to transmit current or signals, which can help to simplify the assembly, facilitate the maintenance & upgrade, improve the design flexibility of electronic products, and therefore are widely used in fields such as computers, electronic appliances, automobiles, communications and industrial automation.

A connector is a plug-in device that connects two active devices to transmit current or signals, which can help to simplify the assembly, facilitate the maintenance, upgrade, and improve the design flexibility of electronic products, and therefore are widely used in fields such as computers, electronic appliances, automobiles, communications and industrial automation. SI performance (electrical and signal integrity performance) is an important indicator for connectors, which aims to measure the characteristic impedance, insertion loss, return loss, near and far end crosstalk of connectors to ensure that they meet the connection function requirement. Conventional solutions for optimizing SI performance involves shielding or filtering external interference signals through adding shielding shells, welding, conductive plastics, etc. These optimization solutions may lead to high design and manufacturing costs, complicated processes, long production duration and poor product qualification rates.

### DESCRIPTION OF THE INVENTION

For eliminating the above-mentioned defects of the prior art, the technical problem to be solved by the present invention is to propose a horizontal connector with a higher SI performance.

The technical solution adopted by the present invention to solve the technical problem is to propose a horizontal connector comprising a casing and several terminal components; the casing is provided with card slots for inserting terminal components and AICs; the terminal components comprise terminal groups and molded parts; the terminal groups comprise ground terminals, first signal terminals and second signal terminals; the casing is uniformly provided with first openings corresponding to terminal heads; the casing is uniformly provided with second openings corresponding to the force arm area of ground terminals; the first openings are provided with serrated inserting holes for limiting the height of terminal heads.

Furthermore, the terminal components comprise a first terminal component, a second terminal component, a third terminal component and a fourth terminal component; the first and third terminal components are set opposite to each other at the left card slot, and the second and fourth terminal component are set opposite to each other at the right card slot; the terminals at the left and right card slots can be grouped in different numbers to meet the connection requirements of different AICs.

Furthermore, the widths of first signal terminals, ground terminals and second signal terminals are the same at the contact area, and the gaps between adjacent terminals are the same; at the terminal force arm area, the structures of first and second signal terminals are symmetrical, and the gaps between adjacent terminals are the same. Ground terminals are wider than first and second signal terminals; at the terminal adhesive sealing area, ground terminals are wider than first and second signal terminals, and a long straight line segment is designed at the junction of terminal groups and molded parts.

Furthermore, the molded parts are provided with holes directly opposing to the ground terminals.

Furthermore, rear stoppers are also used, which are set between the upper/lower terminal group rows, and the number of gaps between the rear stoppers and upper terminal group row as well as between the rear stoppers and lower terminal group row are different depending on the rear stopper positions;

The gap relationship between the rear stoppers and upper/lower terminal group rows is subject to: Vertical Gap F=Vertical Gap E>Vertical Gap D>Vertical Gap B=Vertical Gap A>Vertical Gap C.

Furthermore, metal keys are also used, which are set on both sides of the card slots;

The metal key tops have arc-shaped structures, and the metal key bottoms have a double-elastic-wall structure on both sides. The outer side of each bottom of the double-elastic-wall structures is chamfered, and the two sides of the middle part of each metal key are provided with first support arms.

Furthermore, the casing comprises first convex ribs, which are respectively designed on both sides of each card slot and opposite to each other on the inner sides of the upper/lower casing walls.

Furthermore, the casing has stepped inserting grooves, the front surfaces of the molded parts are chamfered, and the upper or lower surfaces of the front molded parts have trapezoidal convexes.

Furthermore, the front molded parts comprise dovetail slots and dovetail tenons, and the upper/lower molded part rows are terminated through the dovetail slots and dovetail tenons;

The surfaces of dovetail tenons have second convex ribs.

Furthermore, the upper/lower walls of the casing are uniformly provided with inserting ports, and the molded parts have convex bulges.

Furthermore, fixing pieces are also used, which are set at the side wall bottom of each card slot, one side of each fixing piece has an elastic-wall structure, the other side has a stepped structure, and the outer sides of each elastic wall structure and stepped structure are chamfered; the fixing pieces are also provided with second support arms.

Furthermore, a Mylar absorption surface is also provided, which is fixedly attached to the outer side of the upper casing wall.

The horizontal connector proposed by the present invention has the following beneficial effects: By changing the casing structure and optimizing the terminal structure, the characteristic impedance of the terminal groups can be directly optimized and the SI performance of horizontal connectors can be effectively improved, reducing the manufacturing cost for conventional SI performance optimization solutions, simplifying the process, shortening the production time and improving the product qualification rate.

### DESCRIPTION OF THE DRAWINGS

The present invention will be further explained in conjunction with the following drawings and embodiments, for the drawings:

FIG. 1 shows a 3D structure diagram of the horizontal connector of the present invention;

FIG. 2 shows a front view of the horizontal connector of the present invention;

FIG. 3 shows a casing structure diagram of the horizontal connector of the present invention;

FIG. 4 shows a terminal structure diagram of the horizontal connector of the present invention;

FIG. 5 shows a side view of the rear stopper and terminal groups for the horizontal connector of the present invention;

FIG. 6 shows an exploded structure diagram of the upper/lower front molded part rows;

FIG. 7 shows a B-B sectional view of the horizontal connector in FIG. 2;

FIG. 8 show an enlarged view of Part I in FIG. 7;

FIG. 9 shows a metal key structure diagram of the horizontal connector of the present invention;

FIG. 10 shows an A-A sectional view of the horizontal connector in FIG. 2;

FIG. 11 shows a fixing piece structure diagram of the horizontal connector of the present invention;

FIG. 12 shows an C-C sectional view of the horizontal connector in FIG. 2;

FIG. 13 shows a terminal component structure diagram of the horizontal connector of the present invention;

### EXPLANATION OF DRAWING MARKS

Casing 100, card slot 110, first opening 120, inserting hole 121, second opening 130, metal slot 140, first positioning convex 141, first concave 142, first convex rib 150, inserting groove 160, first inserting groove 161, second inserting groove 162, third inserting groove 163, stepped convex 170, inserting port 180, fixing groove 190, second positioning convex 191, second concave 192, Mylar absorption surface 101;
Terminal 200, ground terminal 210, first signal terminal 220, second signal terminal 230, upper terminal group row 240, first terminal group 241, second terminal group 242, lower terminal group row 250, third terminal group 251, fourth terminal group 252, first terminal component 201, second terminal component 202, third terminal component 203, fourth terminal component 204;
Molded part 300, front molded part 310, first front molded part 311, second front molded part 312, third front molded part 313, fourth front molded part 314, rear molded part 320, first rear molded part 321, second rear molded part 322, third rear molded part 323, fourth rear molded part 324, hole 330, dovetail slot 340, dovetail tenon 350, second convex rib 360, trapezoidal convex 370, convex bulge 380;
Metal key 400, arc-shaped structure 410, first notch 420, double-elastic-wall structure 430, first support arm 440;
Fixing piece 500, fixing hole 510, second notch 520, elastic wall structure 530, stepped structure 540, second support arm 550;
Rear stopper 600.

### DETAILED DESCRIPTION OF THE EMBODIMENTS

The following will provide a clear and complete description of the technical solutions regarding the embodiments of the present invention in conjunction with the drawings. It is obvious that the described embodiments are only a part of those of the present invention. Based on the embodiments of the present invention, all other embodiments obtained by common technicians in the art without making creative labor shall fall within the protection of the present invention.

In the description of the present invention, it should be understood that the terms “center”, “longitudinal”, “transverse”, “length”, “width”, “thickness”, “up”, “down”, “front”, “rear”, “left”, “right”, “vertical”, “horizontal”, “top”, “bottom”, “inner”, “outer” and other directional or positional relationships indicated are based on those shown in the drawings and only aim to facilitate the invention description and simplify the corresponding description, rather than indicate or imply that a device or an element indicated must be constructed and operated in a specified direction, and therefore should not be deemed as a limitation to the present invention.

In addition, the terms “first”, “second” and so on are only used for descriptive purposes and should not be understood as indicating or implying their relative importance or implying the number of technical features indicated. Therefore, the features limited to “first” and “second” may explicitly or implicitly include one or more of these features. Unless otherwise specifically limited, in the description of the present invention, “several” means two or more.

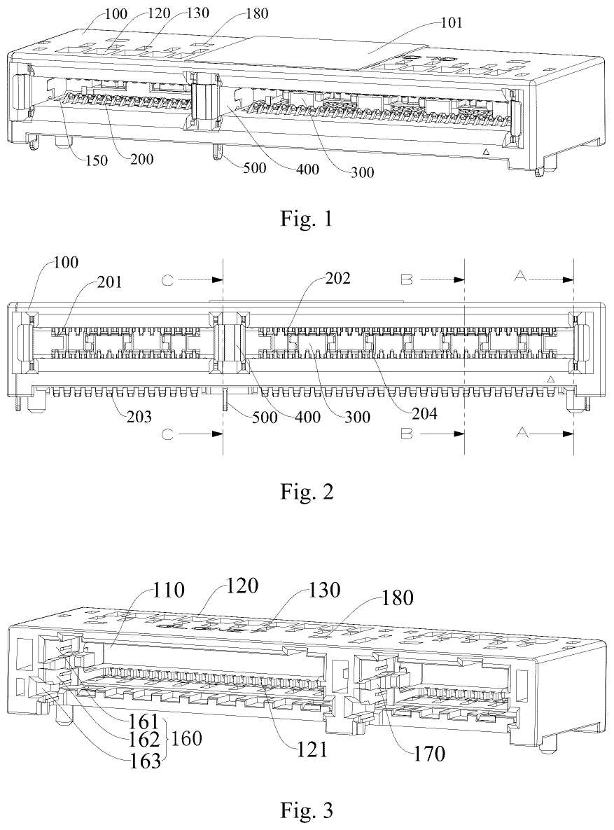

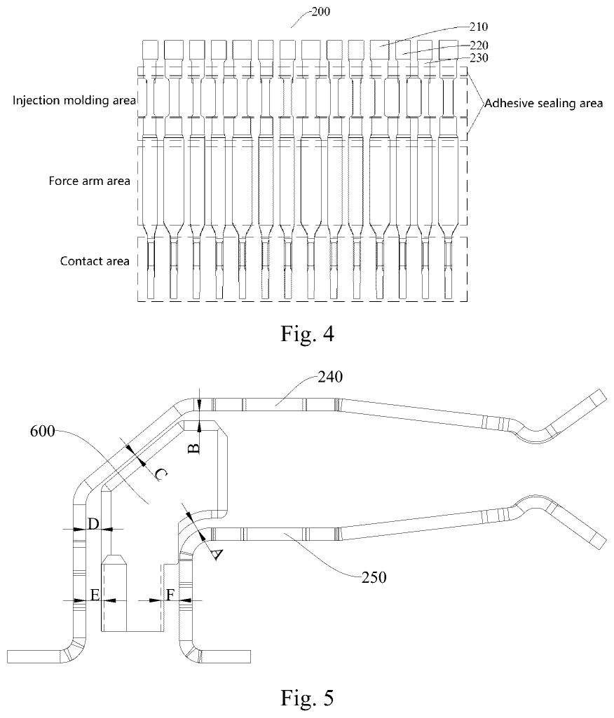

The embodiments of the present invention propose a horizontal connector as shown in FIGS. 1-3, which comprises a casing 100 and several terminal components; the casing 100 is provided with card slots 110 with two opening ends for inserting terminal components and AICs (add-in cards); the terminal groups are composed of terminals 200 as shown in FIG. 4; the terminals 200 include: ground terminals 210, first signal terminals 220, and second signal terminals 230; the terminals of the terminal groups are arranged uniformly in this order. The structure of the terminals, from the front to the back, includes: contact area, force arm area, adhesive sealing area and injection molding area; the contact area is intended for electrical connection between terminals and AICs, which cover bent terminal heads; the injection molding area is covered by molded parts 300; the adhesive sealing area is intended for connection between terminals and molded parts 300; the tail of each terminal also includes fillets for welding connection. The upper and lower walls of the casing 100 are provided with uniformly consistent first openings 120 and second openings 130; the first openings 120 faces terminal heads, while the second openings 130 faces the force arm area of ground terminals 210; The setting of first openings 120 and second openings 130 can help to optimize the characteristic impedance of terminal groups and effectively improve the SI performance of horizontal connectors.

As shown in FIG. 4, the first signal terminals 220 and second signal terminals 230 are respectively set on both sides of each ground terminal 210; the ground terminals 210 are used for transmitting ground signals, while the signal terminals (including first signal terminals 220 and second signal terminals 230) are used for transmitting differential signals. Ground terminals 210, first signal terminals 220 and second signal terminals 230 have different structural designs at different sections; at the contact area of terminals, the widths of the three types of terminals are the same, and the distances between adjacent terminals are the same; at the force arm area of terminals, the structures of first signal terminals 220 and second signal terminals 230 are symmetrical, the distances between adjacent terminals are the same, and ground terminals 210 are wider than signal terminals; at the adhesive sealing area of terminals, ground terminals 210 are wider than signal terminals. The different width and gap designs for the three types of terminals are helpful for reducing crosstalk resonance and characteristic impedance generated by terminals during signal transmission, and improving the SI performance of horizontal connectors. At the adhesive sealing area of terminals, a long straight line segment is designed at the junction of terminals and molded parts 300, which can ensure that no adhesive overflow will be caused during an injection molding process.

Furthermore, as shown in FIG. 13, in some embodiments the terminal components comprise a first terminal component 201, a second terminal component 202, a third terminal component 203 and a fourth terminal component 204; the card slots 110 comprise a left card slot and a right card slot, where the first terminal component 201 and second terminal component 202 belong to the upper terminal component row, while the third terminal component 203 and fourth terminal component 204 belong to the lower terminal component row; the first terminal component 201 and third terminal component 203 are opposite to each other at the left card slot, and the second terminal component 202 and fourth terminal component 204 are opposite to each other at the right card slot. The terminal components are injection-molded through terminal groups, and each terminal component includes two molded parts 300 at the front and rear ends; the front molded parts 310 are set at the injection molding area of terminals and assembled in the middle of the card slots; the rear molded parts 320 are set at the tail of terminals and at the front end of fillets, and assembled at the rear end of the card slots. Specifically, the first terminal component 201 includes a first terminal group 241, a first front molded part 311 and a first rear molded part 321; the second terminal component 202 includes a second terminal group 242, a second front molded part 312 and a second rear molded part 322; the third terminal component 203 includes a third terminal group 251, a third front molded part 313, and a third rear molded part 323; the fourth terminal component 204 includes a fourth terminal group 252, a fourth front molded part 314 and a fourth rear molded part 324. In the embodiment drawings of the present invention, the first terminal component 201 and third terminal component 203 have 14-pin terminals, and the second terminal component 202 and fourth terminal component 204 have 28-pin terminals; During a concrete application, the terminals at the left and right card slots can be grouped in different numbers to meet the connection requirements of different AICs.

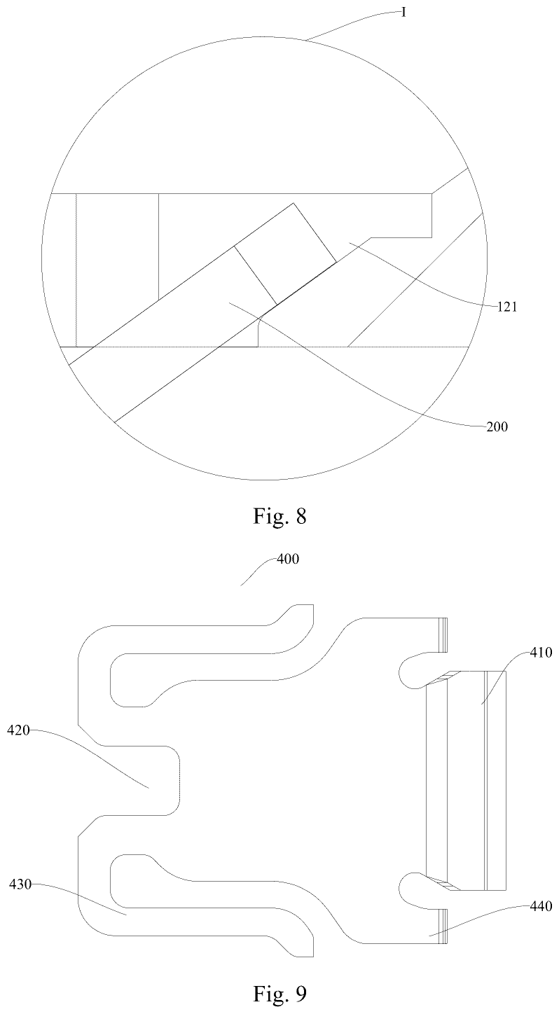

Furthermore, as shown in FIGS. 3, 7 and 8, in some embodiments, the first openings 120 are also provided with serrated inserting holes 121, and each inserting hole 121 has its corresponding terminal; an inserting hole 121 is slightly wider than a terminal head, namely the gap between a terminal head and an inserting hole 121 is very narrow, limiting flicking of the terminal head. The inserting holes 121 are serrated, and the obliquity of the serrations is the same as the bending degree of the terminal heads, namely the obliquity of the serrations is parallel to the terminal heads; after the terminal components are assembled, the terminal heads are in contact with the inserting holes 121; thanks to the restriction of the inserting holes 121, over high elastic height of terminal groups can be avoided, which is helpful for adjusting the elastic height coplanarity size of the terminal groups.

Furthermore, in some embodiments, as shown in FIG. 5, the horizontal connector further comprises rear stoppers 600; the rear stoppers are set between the upper terminal component row and lower terminal component row; the rear stoppers 600 are irregular; their outer surface shapes include horizontal planes, inclined planes and vertical planes; their inner surface shapes include horizontal planes, curved planes and vertical planes. The gaps between the rear stoppers 600 and upper/lower terminal groups (240/250) are different depending on the positions of the terminals. Among them, the gap between the horizontal plane for the outer surface of a rear stopper 600 and the upper terminal group row 240 is B; the gap between the inclined plane for the outer surface of the rear stopper 600 and the upper terminal group row 240 (including the first terminal group 241 and second terminal group 242) is C; the gap between the first vertical plane for the outer surface of the rear stopper 600 and the upper terminal group row 240 is D; the gap between the second vertical plane for the outer surface of the rear stopper 600 and the upper terminal group row 240 is E; the gap between the horizontal plane and curved surface for the inner surface of the rear stopper 600 and the lower terminal group row 250 (including the third terminal group 251 and the fourth terminal group 252) is A; the gap between the vertical plane for the inner surface of the rear stopper 600 and the lower terminal group row 250 is F; the specific relationships regarding Gap A to F is subject to: F=E>D>A=B>C; by adjusting the gap between the rear stoppers 600 and terminal groups, the impedance, resonance and SI performance of horizontal connectors can be effectively improved.

The rear stoppers comprise a first rear stopper and a second rear stopper; the first rear stopper is set at the left card slot, namely between the first terminal component 201 and third terminal component 203, and between the front and rear molded parts 320; the second rear stopper is set at the right card slot, namely between the second terminal component 202 and fourth terminal component 204, and is arranged side by side with the first rear stopper.

It should be noted that during assembly, the lower terminal component row should be first riveted into the card slot 110 with a fixture; the terminal heads of the lower terminal group row 250 should be fixed in the inserting holes 121 on the lower wall of the casing 100, and then the rear stopper 600 should be riveted into the card slot 110 with a fixture; the rear stopper 600 should be set above the lower terminal component row; the upper terminal component row should be riveted into the card slot 110; the terminal heads of the upper terminal component row should be fixed in the inserting holes 121 on the upper wall of the casing 100 and then the upper terminal component row should be set above the rear stopper 600.

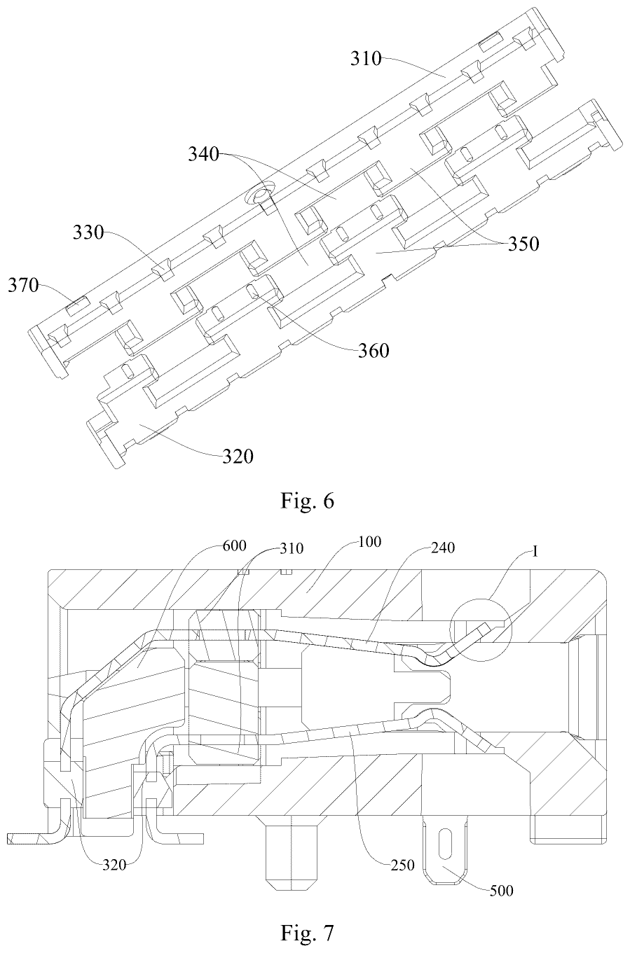

Furthermore, in some embodiments, as shown in FIGS. 2, 6 and 13, the front molded parts 310 (the first to fourth front molded parts) are provided with dovetail slots 340 and dovetail tenons 350; the dovetail slots 340 and dovetail tenons 350 of the upper front molded part row (including the first front molded part 311 and second front molded part 312) and lower front molded part row (including the third front molded part 313 and fourth front molded part 314) are misaligned with each other, namely the dovetail slots 340 and dovetail tenons 350 of the first front molded part 311 and third front molded part 313 as well as those of the second front molded part 312 and fourth front molded part 314 are misaligned with each other, so the dovetail slots 340 of the upper front molded part row and the dovetail tenons 350 of the lower front molded part row can be slot-tenon connected, ensuring the tight locking and firm assembly between the upper front molded part row and lower front molded part row; due to the stress interaction, plastic warping and deformation can be prevented, ensuring the elastic height of terminal groups and the coplanarity size of fillets.

Furthermore, the surfaces of the dovetail tenons 350 are also provided with second convex ribs 360; the second convex ribs 360 can achieve an interference fit between each dovetail slot 340 and tenon, making the connection between the upper front molded part row and lower front molded part row more secure.

Furthermore, in some embodiments, the molded parts 300 have holes 330; the holes are set in the injection molding area of terminals and directly face the ground terminals 210. The design of the holes 330 is helpful for improving the resonance and SI performance of horizontal connectors.

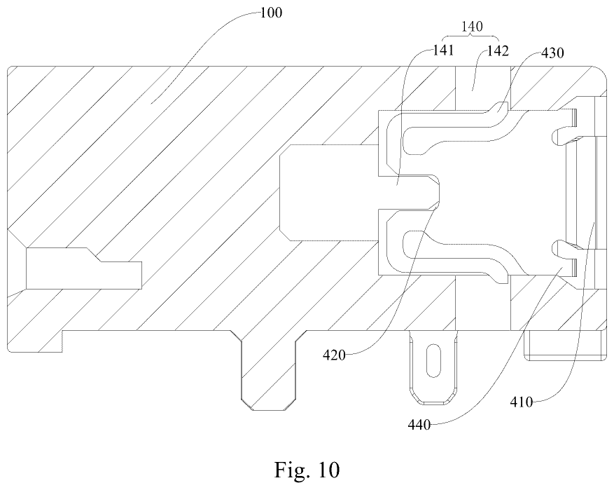

Furthermore, in some embodiments, as shown in FIGS. 9 and 10, metal keys 400 are also provided on both sides of each card slot 110 of the horizontal connector; the metal keys 400 are set in the metal slots 140 on the inner wall of the front end rabbets for the casing 100 card slots. For a metal key 400, one end has an arc-shaped structure 410, and the other end has a first notch 420; the bottom of the metal key 400 has a double-elastic-wall structure 430 on both sides, and the first notch 420 is set between the double-elastic-wall structures 430; the outer sides of the double elastic wall structure 430 bottoms are chamfered, and the middle two sides of the metal key 400 are provided with first support arms 440. The rabbet of each metal slot 140 has a chamfer structure, which matches with the chamfer on the double-elastic-wall structure 430 of the metal key 400, making the metal key 400 be smoothly inserted into the metal slots 140. For a metal slot, the bottom is also provided with a first positioning convex 141; the first positioning convex 141 fits seamlessly with the first notch 420 to ensure the correct inserting position of a metal key 400. A first concave 142 matching with the double-elastic-wall structures 430 is also provided in the metal slot 140; when the metal key 400 reaches the bottom of the metal slot 140, the double-elastic-wall structures 430 will extend to both sides to support the casing 100, preventing a loose insertion and ensuring an easy disassembly. Support arms of metal keys 400 are connected to metal slots 140 through interference fit; when a metal key 400 is inserted into a metal slot 140, the support arm will further help to stabilize and secure the insertion. After the metal key 400 is inserted in place, the arc-shaped structure 410 can wrap around the side wall of the casing 100 in reverse. The surface of the metal key 400 is smooth, and the arc-shaped structure 410 is good for guiding, allowing AICs to be smoothly inserted even at a big insertion angle.

Metal keys 400 include side metal keys and middle metal keys; the side metal keys are set on the left side of the left card slot and the right side of the right card slot, respectively, while the middle metal keys are set on the right side of the left card slot and the left side of the right card slot. For an easier assembly's sake, the arc-shaped structures 410 of the two middle metal keys are jointed together, making the two middle metal keys be used as a whole.

Furthermore, in some embodiments, the two sides of the front end rabbet of each card slot 110 also have first convex ribs 150; the first convex ribs 150 are opposite to each other and set on the inner side of the upper/lower walls of the casing 100. The design of the first convex ribs 150 can make card insertion more secure, and also keep each card in the middle, ensuring a reliable contact.

Furthermore, in some embodiments, as shown in FIG. 3, the side wall of the casing 100 also has inserting grooves 160 and trapezoidal convexes 170. The width and thickness of the trapezoidal convexes 170 increase from the rear end to the front end of a card slot 110, and the inserting grooves 160 are stepped; the width of the inserting grooves 160 gradually decreases from the rear end to the front end of the card slot 110. the molded parts 300 are chamfered, and the upper or lower surface of the front molded part 310 has trapezoidal convexes 370, which can provide an easier guidance for molded parts 300 during assembly and help to better correct the inserting position; the layer-by-layer narrowing slot 110 design can also make molded parts 300 more firmly inserted in the casing 100.

Specifically, the inserting grooves 160 include a first inserting groove 161, a second inserting groove 162 and a third inserting groove 163; the first inserting groove 161 and second inserting groove 162 are symmetrical, and the third inserting groove 163 is formed by concaving the side wall of the casing 100; the second inserting groove 162 is set below the first inserting groove 161, and the third inserting groove 163 is set behind the second inserting groove 162. The upper front molded part row (including the first front molded part 311 and second front molded part 312) are fit in the first inserting groove 161, and the lower front molded part row (including the third front molded part 313 and fourth front molded part 314) are fit in the second inserting groove 162; the two end structures of the upper and lower front molded part rows are the same and symmetrically set; the lower surface of the upper front molded part row and the upper surface of the lower front molded part row have trapezoidal convexes 370; the trapezoidal convexes are right-angled and trapezoidal with inclined planes facing the front end; the front surfaces of the two ends of the upper/lower front molded part rows are chamfered. The upper rear molded part row (including the first rear molded part 321 and second rear molded part 322) and lower rear molded part row (including the third rear molded part 323 and fourth rear molded part 324) are fit in the third inserting groove 163, and the lower rear molded part row is smaller than the upper rear molded part row; the lower rear molded part row is fit at the front end of the third inserting groove, the upper rear molded part row is fit at the rear end of the third inserting groove 163, and the front surfaces of both ends of the upper/lower rear molded part rows are chamfered.

Furthermore, in some embodiments, the upper and lower walls of the casing 100 are provided with uniform inserting ports, and the upper surface of the upper front molded part row and the lower surface of the lower front molded part row are provided with corresponding convex bulges 380; when terminal components are assembled into the casing 100, the convex bulges 380 can help to prevent receding.

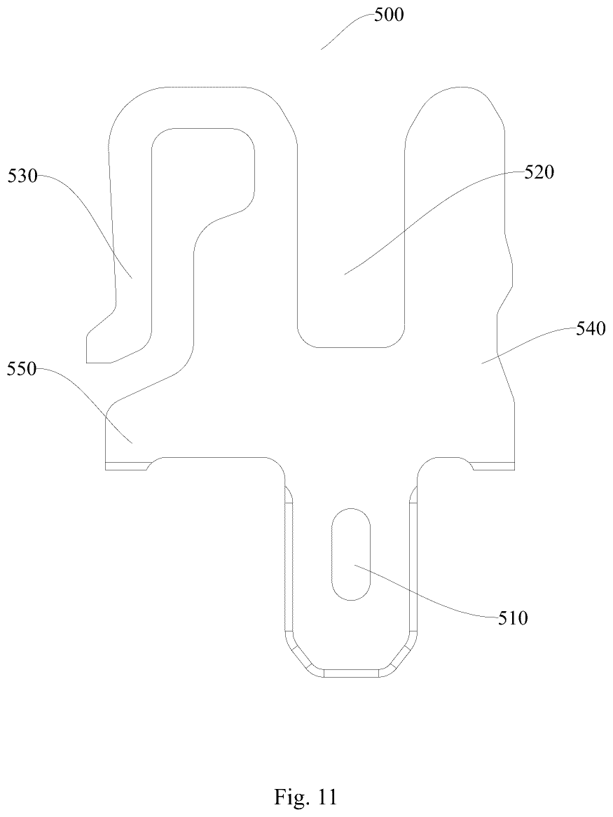

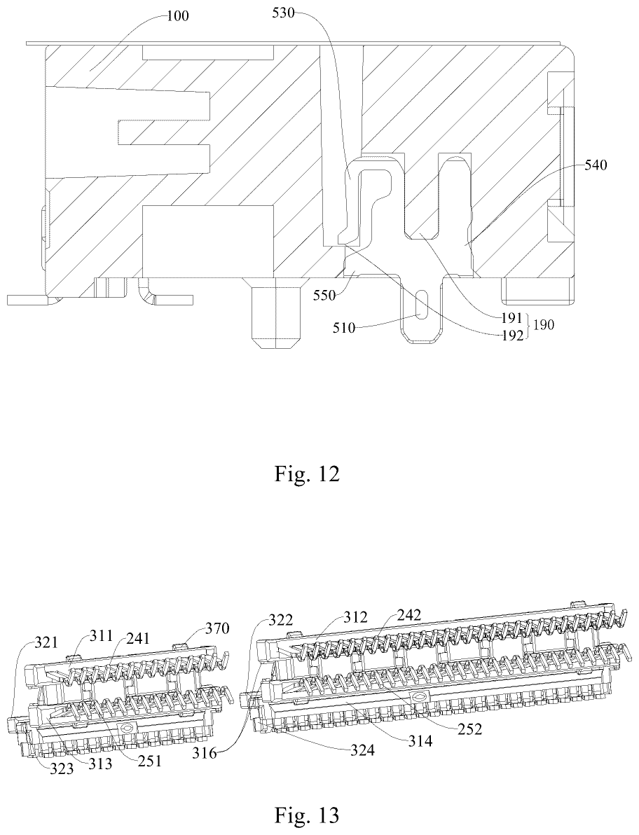

Furthermore, in some embodiments, as shown in FIGS. 11 and 12, the horizontal connector further comprises fixing pieces 500; the fixing pieces 500 are set at the bottom of the casing 100; Specifically, a fixing groove 190 is provided on the side wall of the casing 100, and the rabbet of the fixing groove 190 faces downward; one end of each fixing piece 500 has a fixing hole 510, and the other end has a second notch 520; one side of each fixing piece 500 has an elastic wall structure 530, and the other side has a stepped structure 540; the outer sides of the elastic wall structure 530 and stepped structure 540 are chamfered, and the second notch 520 is set on the inner side of the elastic wall structure 530 and stepped structure 540; a second support arm 550 is also provided above the elastic wall structure 530. The rabbet of the fixing groove 190 is chamfered, which matches with the outer chamfers of the elastic wall structure 530 and stepped structure 540, making the fixing piece 500 be smoothly inserted into the fixing groove 190. For the fixing groove 190, the bottom is provided with a second positioning convex 191; the second positioning convex 191 fits seamlessly with the second notch 520 to ensure the correct inserting position of the fixing piece 500. A second concave 192 matching with the elastic wall structure 530 is also provided in the fixing groove 140; when the fixing piece 500 reaches the bottom of the fixing groove 190, the elastic wall structure 530 will extend to the outer side to support the casing 100, preventing a loose insertion and ensuring an easy disassembly. The stepped structure 540 can make the interference to the fixing piece 500 increase during assembly, ensuring a firm insertion of the fixing piece 500. The second support arm 550 is connected to the fixing groove 190 through interference fit, ensuring secure insertion of the fixing piece 500. Fixing pieces 500 are used for securing the horizontal connector during assembly.

Furthermore, in some embodiments, the horizontal connector is also provided with a Mylar suction surface, which is fixedly connected to the outer surface of the upper casing wall; the Mylar suction surface 101 is smooth, and therefore, through the Mylar suction surface 101, the horizontal connector can be absorbed to move.

By changing the casing structure and optimizing the terminal structure, the characteristic impedance of the terminal groups can be directly optimized and the SI performance of horizontal connectors can be effectively improved, reducing the manufacturing cost for conventional SI performance optimization solutions, simplifying the process, shortening the production time and improving the product qualification rate.

Those details not described in this specification belongs to the prior art known to professionals in this field.

The above embodiments are only for illustrating the technical concept and characteristics of the present invention, and intended to enable those skilled in this technology to understand the content of the present invention and make an application accordingly, which should not be considered as a limitation to protection of the present invention. Any equivalent changes and modifications made to the claims of the present invention shall fall within the claims of the present invention.

It should be understood that for those skilled in the art, improvements or modifications can be made based on the above description, and all such improvements and modifications should fall within the protection of the claims regarding the present invention.

1. A horizontal connector, which is characterized by composing of a casing and several terminal components; the casing is provided with card slots for inserting terminal components and AICs; the terminal components comprise terminal groups and molded parts; the terminal groups comprise ground terminals, first signal terminals and second signal terminals; the casing is uniformly provided with first openings corresponding to terminal heads; the casing is uniformly provided with second openings corresponding to the force arm area of ground terminals; the first openings are provided with serrated inserting holes for limiting the height of terminal heads.

2. The horizontal connector according to claim 1, which is characterized in that the terminal components comprise a first terminal component, a second terminal component, a third terminal component and a fourth terminal component; the first and third terminal components are set opposite to each other at the left card slot, and the second and fourth terminal component are set opposite to each other at the right card slot; the terminals at the left and right card slots can be grouped in different numbers to meet the connection requirements of different AICs.

3. The horizontal connector according to claim 1, which is characterized in that the widths of first signal terminals, ground terminals and second signal terminals are the same at the contact area, and the gaps between adjacent terminals are the same; at the terminal force arm area, the structures of first and second signal terminals are symmetrical, and the gaps between adjacent terminals are the same. Ground terminals are wider than first and second signal terminals; at the terminal adhesive sealing area, ground terminals are wider than first and second signal terminals, and a long straight line segment is designed at the junction of terminal groups and molded parts.

4. The horizontal connector according to claim 1, which is characterized in that the molded parts are provided with holes directly opposing to the ground terminals.

5. The horizontal connector according to claim 1, which is characterized in that rear stoppers are also used; the rear stoppers are set between the upper/lower terminal group rows, and the number of gaps between the rear stoppers and upper terminal group row as well as between the rear stoppers and lower terminal group row are different depending on the rear stopper positions;
The gap relationship between the rear stoppers and upper/lower terminal group rows is subject to: Vertical Gap F=Vertical Gap E>Vertical Gap D>Vertical Gap B=Vertical Gap A>Vertical Gap C.

6. The horizontal connector according to claim 1, which is characterized in that metal keys are also used; the metal keys are set on both sides of the card slots;
The metal key tops have arc-shaped structures, and the metal key bottoms have a double-elastic-wall structure on both sides. The outer side of each bottom of the double-elastic-wall structures is chamfered, and the two sides of the middle part of each metal key are provided with first support arms.

7. The horizontal connector according to claim 1, which is characterized in that the casing comprises first convex ribs; the first convex ribs are respectively designed on both sides of each card slot and opposite to each other on the inner sides of the upper/lower casing walls.

8. The horizontal connector according to claim 1, which is characterized in that the casing has stepped inserting grooves, the front surfaces of the molded parts are chamfered, and the upper or lower surfaces of the front molded parts have trapezoidal convexes.

9. The horizontal connector according to claim 1, which is characterized in that the front molded parts comprise dovetail slots and dovetail tenons, and the upper/lower molded part rows are terminated through the dovetail slots and dovetail tenons;
The surfaces of dovetail tenons have second convex ribs.

10. The horizontal connector according to claim 1, which is characterized in that the upper/lower walls of the casing are uniformly provided with inserting ports, and the molded parts have convex bulges.

11. The horizontal connector according to claim 1, which is characterized in that fixing pieces are also used; the fixing pieces are set at the side wall bottom of each card slot, one side of each fixing piece has an elastic-wall structure, the other side has a stepped structure, and the outer sides of each elastic wall structure and stepped structure are chamfered; the fixing pieces are also provided with second support arms.

12. The horizontal connector according to claim 1, which is characterized in that a Mylar absorption surface is also provided; the Mylar absorption surface is fixedly attached to the outer side of the upper casing wall.
